(19) United States
(12) Patent Application Publication
(10) Pub. No.: US 2009/0177982 A1
(43) Pub. Date: Jul. 9, 2009

(54) METHOD FOR RETRIEVING REAL-TIME NETWORK INFORMATION AND MOBILE COMMUNICATION DEVICE USING THE SAME

(76) Inventors: Shih-Wen WENG, Taipei (TW); Hsiao-Pei Shih, Taipei (TW)

Correspondence Address: BIRCH STEWART KOLASCH & BIRCH, PO BOX 747, FALLS CHURCH, VA, 22040-0747, US

(21) Appl. No.: 12/191,953

(22) Filed: Aug. 14, 2008

(30) Foreign Application Priority Data
Jan. 4, 2008 (TW) 097100318

(51) Int. Cl. G06F 17/00

(52) U.S. Cl. 715/760

(57) ABSTRACT

A method for retrieving real-time network information is provided. At least one subscribed web page and at least one data field in the page are set via an operating interface provided by a mobile communication device and at least one comparison data corresponding to the data field is set. Contents of the subscribed web page are retrieved via a network using the mobile communication device and are compared with the comparison data to determine whether the contents have been changed. If it is determined that the contents have been changed, a notice message is sent by the mobile communication device and displayed on the screen of the mobile communication device.

### CROSS-REFERENCE TO RELATED APPLICATIONS

This nonprovisional application claims priority under 35 U.S.C. §119(a) on Patent Application No. 097100318, filed in Taiwan on Jan. 4, 2008, the entirety of which is incorporated herein by reference.

### BACKGROUND OF THE INVENTION

1. Field of the Invention

The present invention relates to a method for data processing, more particularly to a method for retrieving real-time network information and a mobile communication device using the same.

2. Background of the Invention

Nowadays, some information such as stock price, currency exchange rate, stock market index, etc. is changed momentarily. However, people sometimes are too busy to wait for the information in front of the television set or the computer. Therefore, it is difficult for them to retrieve the real-time information.

At present, mobile communication devices (e.g., personal digital assistant (PDA)) provide the function to wirelessly surf on the Internet, using the technology such as GPRS (General Packet Radio Service), 3G (Third Generation Wireless Format), etc., which enable the users to access the Internet and browse information on the web pages to retrieve the information they want.

Although the mobile communication devices can provide the services to retrieve the information on the Internet, the user has to manually access to the Internet to retrieve the information. However, for the information such as stock/exchange market, the user needs to be informed instantly. Conventional mobile communication device provided to surf on the Internet is unable to automatically retrieve the real-time information.

### SUMMARY OF THE INVENTION

One of the objects of the present invention is to provide a method for retrieving real-time network information. At least one subscribed web page and at least one data field in the page are set via an operating interface provided by a mobile communication device and at least one comparison data corresponding to the data field is set. Contents of the subscription web page are retrieved via a network using the mobile communication device and are compared with the comparison data to determine whether the contents have been changed. If it is determined that the contents have been changed, a notice message is sent by the mobile communication device and displayed on the screen of the mobile communication device.

A mobile communication device for retrieving real-time network information is also provided, which includes a screen, a network module, and a memory module. The memory module has an application program and the application program provides an operating interface. At least one subscribed web page and at least one data field in the page are set via the application program according to a set operation and at least one comparison data corresponding to the data field is set. Contents of the subscription web page are retrieved via a network using the mobile communication device and are compared with the comparison data, determining whether the comparison data has been changed. If it has, a piece of notice message is sent by the mobile communication device and displayed on the screen of the mobile communication device.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below and the accompanying drawings which are given by way of illustration only, and thus are not limitative of the present invention, and wherein:

FIG. 1 is a flow chart of a method for retrieving real-time network information according to one embodiment of the present invention; and

FIG. 2 is a block diagram of a mobile communication device according to one embodiment of the present invention.

### DETAILED DESCRIPTION OF THE ILLUSTRATED EMBODIMENTS

The present invention will now be described in detail with reference to the accompanying drawings, wherein the same reference numerals will be used to identify the same or similar elements throughout the several views. It should be noted that the drawings should be viewed in the direction of orientation of the reference numerals.

An embodiment of the present invention to illustrate a method for retrieving real-time network information and a mobile communication device using the same method is described hereinbelow.

The mobile communication device is provided with instant action function using the tendency of surf on the Internet and the demand for real-time information. When the set information has been changed, the mobile communication device can display the changed information automatically and instantly, such as, the fluctuations of stock price, the change of currency exchange rate, the bidding price, etc.

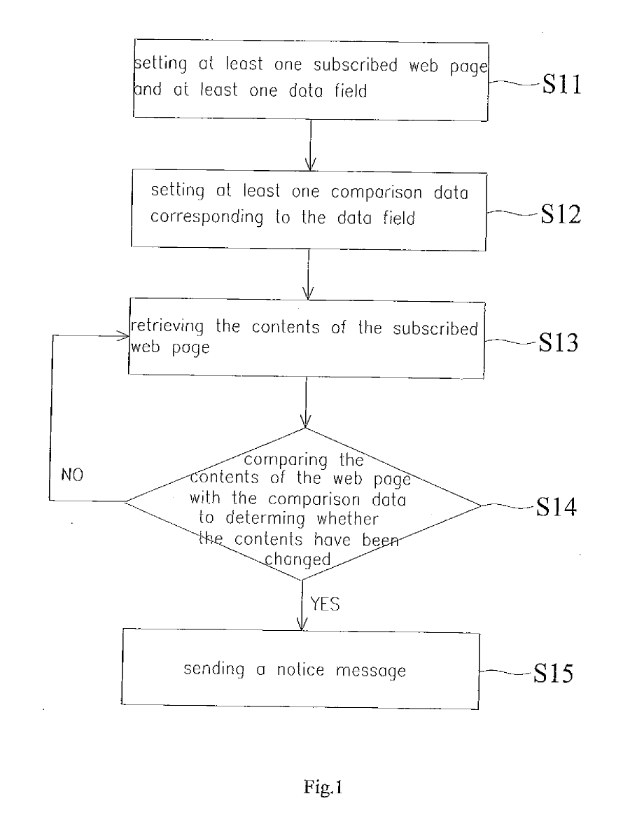

FIG. 1 shows a flow chart of a method for retrieving real-time network information according to one embodiment of the present invention.

First, the user can set at least one subscribed web page (such as the web pages the user browses very often), and at least one data field in the web page which the user wants to retrieve via the operating interface provided by a mobile communication device (step 11). Then, the user sets at least one comparison data corresponding to the data field, such as a character, a number, a symbol or any combination thereof (step 12). For example, the mobile communication device can be set to send a notice message when the stock price of company A is higher than 30 dollars or lower than 25 dollars, or when the bidding price of goods B is higher than 500 dollars.

Contents of the subscribed web page are retrieved via a network (such Internet) using the mobile communication device (step 13), and are compared with the comparison data (such as a character, a number, a symbol or any combination thereof), to determine whether the contents have been changed (step 14), i.e., to detect whether the contents are outside of a predefined range or do not match to a keyword(s). If it is determined that the contents have been changed, a notice message is sent by the mobile communication device and displayed on the screen of the mobile communication device (step 15). According to the notice message, the user determines whether he/she needs to take a subsequent action. If yes, the user can access the mobile communication device to the subscribed web page according to the notice message.

For example, when the stock price of company A is higher than 30 dollars or lower than 25 dollars, the mobile communication device sends a notice message to notify the user. Then the user can determine whether he/she needs to buy or sell out the stock of company A, or inquire some information about company A. When the bidding price of object B is higher than 500 dollars, the mobile communication device sends a notice message to notify the user. Then the user can determine whether to continue bidding or not.

Taking the Windows Mobile Phone for example, the application program for retrieving the realtime network information of the present invention is applied to the mobile communication device. After setting the individual web page, the mobile communication device can access to the defined web page via a wireless network or 3G. When the information of defined web page has been changed, the application program automatically sends a notice message to remind the user of what happened with the information. The user can use the mobile communication device to access to the defined web page if he/she wants to know the details of the information. If not, the user can close the window of displaying the notice message which is stored in a historical information list to be read by the user.

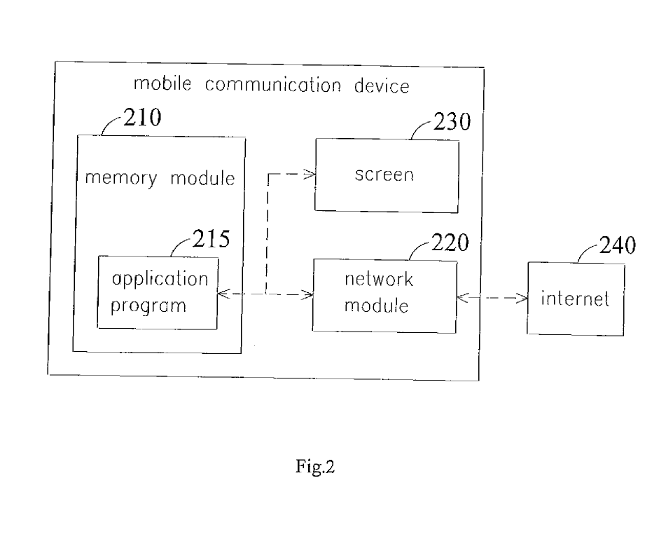

FIG. 2 shows a block diagram of a mobile communication device according to one embodiment of the present invention.

In the illustrated embodiment of the present invention, the mobile communication device 200 comprises at least a memory module 210, a network module 220, and a screen 230. The application program 215 for retrieving the real-time network information is installed in the memory module 210.

At least one subscribed web page and at least one data field in the page are set by the user via the operating interface using the application program 215. At least one comparison data corresponding to the data field such as a character, a number, a symbol and any combination thereof is set, which represents the network information the user desires. For example, the mobile communication device can be set to send a notice message when the stock price of company A is higher than 30 dollars or lower than 25 dollars, or when the bidding price of object B is higher than 500 dollars.

The mobile communication device 200 can access to one network 240 (such as Internet) via the network module 220 to retrieve the contents of the subscribed web page. The contents of the subscribed web page are compared with the comparison data corresponding to the data field using the application program 215 to determine whether the contents, such as a character, a number, a symbol and any combination thereof, have been changed. To detect whether the keywords such as a number, a character in the data field have been changed, it is determined whether the keywords correspond to the user's setting or the number/price fluctuates within a predefined range. If it is determined that the contents have been changed, a notice message is sent using the application program 215 and is displayed on the screen 230 of the mobile communication device. According to the notice message, the user determines whether he/she needs to take a subsequent action. If yes, the user can access to the subscribed web page via the network module 220 according to the notice message.

It should be noted that the comparison data can be set using a personal computer (not shown) alternatively, and can be transmitted to the mobile communication device 200 after setting to perform subsequent comparison.

Using the illustrated method, the user only needs to set relevant options on the mobile communication device. The mobile communication device automatically searches for the contents from the predetermined web page(s) after the options are set. If there is any change of the real-time information in the predetermined web page(s), the mobile communication device will send a short message to the user to remind him of the latest information instantly.

A storage medium (such as a compact disk, a magnetic disk, a removable hard disk, etc.) is provided. It records an approval program to which the computer can access to execute the method for retrieving the real-time network information. The approval program stored in the storage medium includes several program code segments, such as a segment for creating organization framework, a segment for approval sheet, a segment for setting data, and a segment for arrangement. The function of the program code segments corresponds to the steps according to the above mentioned method and the functional blocks of the mobile communication device.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A method for retrieving real-time network information comprising:
setting at least one subscribed web page and at least one data field via an operating interface provided by a mobile communication device;
setting at least one comparison data corresponding to the data field;
retrieving contents of the subscribed web page via a network using the mobile communication device;
comparing the contents of the subscribed web page with the comparison data corresponding to the data field, and determining whether the contents of the subscribed web page have been changed; and
if it is determined that the contents of the subscribed web page have been changed, sending a notice message by the mobile communication device and displaying the notice message on a screen of the mobile communication device.

2. The method of claim 1, further comprising accessing to the subscribed web page via the network according to the notice message.

3. The method of claim 1, wherein the step of determining whether the contents have been changed includes detecting whether the contents are within a predefined range or match to a keyword.

4. The method of claim 3, wherein the notice message is sent via the mobile communication device when a value of the contents exceeds a first predefined range, larger than a second predefined range, smaller than a third predefined range, or between a forth and a fifth predefined range.

5. The method of claim 1, wherein the comparison data is a character, a number, symbol, or any combination thereof, which represents network information desired by a user.

6. A mobile communication device, comprising:
a screen;
a network module; and
a memory module embodying an application program providing an operating interface, wherein the application program is executed to set at least one subscribed web page and at least one data field in the subscribed web page via the operating interface, and to set at least one comparison data corresponding to the data field, and the network module accesses to a network to retrieve contents of the subscribed web page, to determine whether the contents have been changed after compared with the comparison data, and if it is determined that the contents of the subscribed web page have been changed, the application program is executed to send a notice message so that the notice message is displayed on the screen.

7. The mobile communication device according to claim 6, wherein the application program responds to the notice message and makes the mobile communication device access to the subscribed web page via a network using the network module.

8. The mobile communication device according to claim 6, wherein to determine whether the contents have been changed is to detect whether the contents is within a predefined range or matches to a key words.

9. The mobile communication device according to claim 8, wherein the notice message is sent when a value of the contents exceeds a first predefined range, larger than a second predefined range, smaller than a third predefined range, or between a forth and a fifth predefined range.

10. The mobile communication device according to claim 6, wherein the comparison data is a character, a number, a symbol, or any combination thereof, which represents network information desired by a user.

11. A computer readable medium for storing computer executable instructions, wherein the computer executable instructions are executed to perform the steps of:
setting at least one subscribed web page and at least one data field via an operating interface provided by a mobile communication device;
setting at least one comparison data corresponding to the data field;
retrieving contents of the subscribed web page via a network using the mobile communication device;
comparing the contents of the subscribed web page with the comparison data corresponding to the data field to determine whether the contents have been changed, and
if it is determined that the contents have been changed, sending a notice message and displaying the notice message on a screen of he mobile communication device.

12. The computer readable medium according to claim 11, wherein the computer executable instructions are executed to further perform the step of accessing to the subscribed web page via the network according to the notice message.

13. The computer readable according to claim 11, wherein the step of determining whether the contents have been changed includes detecting whether the contents are within a predefined range or match to a keyword.

14. The computer readable according to claim 13, wherein the notice message is sent via the mobile communication device when a value of the comparison data exceeds a first predefined range, larger than a second predefined range, smaller than a third predefined range, or between a forth and a fifth predefined range.

15. The computer readable according to claim 11, wherein the comparison data is a character, a symbol, or any combination thereof, which represents network information desired by a user.
